(19) United States
(12) Patent Application Publication
(10) Pub. No.: US 2026/0176042 A1
(43) Pub. Date: Jun. 25, 2026

(54) PACKAGING MATERIALS WITH IMPROVED RECYCLABILITY

(71) Applicant: SmartSolve Industries LLC, Bowling Green, OH (US)

(72) Inventors: Jonathan Jakubowski, Bowling Green, OH (US); Bruno Pereira, Bowling Green, OH (US); Giuseppe Giammanco, Bowling Green, OH (US)

(73) Assignee: SmartSolve Industries LLC, Bowling Green, OH (US)

(21) Appl. No.: 19/426,451

(22) Filed: Dec. 19, 2025

Related U.S. Application Data
(60) Provisional application No. 63/736,719, filed on Dec. 20, 2024.

(51) Int. Cl. B65D 65/40; B32B 27/10; B32B 27/30; B32B 27/32; B65D 75/00; B65D 75/58

(52) U.S. Cl. CPC B65D 65/40; B32B 27/10; B32B 27/306; B32B 27/32; B65D 75/008; B65D 75/5883; B32B 2307/7166; B32B 2439/00

(57) ABSTRACT

Described is a packaging material that includes a first layer having a water-dispersible material and a second layer having a plastic material. The packaging material may be formed into a package of a desired shape and configuration where the first layer forms an exterior surface, or in other embodiments the interior surface, of the package. This allows for effective packaging of liquids and moisture-sensitive products while maintaining structural integrity and providing for improved recyclability of the package and the ability to have printed indicia on the exterior surface of the package.

### RELATED APPLICATIONS

This application claims priority to U.S. Provisional Application No. 63/736,719, filed under 35 U.S.C. § 111(b) on Dec. 20, 2024, the disclosure of which is incorporated herein by reference in its entirety.

### BACKGROUND

Packaging plays a vital role in preserving and protecting products across various industries, including in the food, beverage, agricultural, and personal care sectors. Non-biodegradable plastic materials have long been the materials of choice for packaging due to their moisture barrier properties, chemical resistance, and mechanical strength. These properties ensure that products remain uncontaminated and retain their quality during transportation and storage. However, recycling such packaging is often complicated by the inclusion of inks and other materials or contaminants. There is a need in the art for new and improved packaging materials that are easier to mechanically recycle.

### SUMMARY

Provided herein is a packaging material comprising a first layer comprising a water-dispersible paper, wherein the first layer meets at least one requirement selected from the group consisting of ISO 20200 for disintegration and FG502 for flushability; and a second layer in direct contact with the first layer, the second layer comprising a plastic material.

In certain embodiments, the packaging material consists of the first layer and the second layer.

In certain embodiments, the water-dispersible paper comprises carboxymethyl cellulose. In certain embodiments, the water-dispersible paper comprises carboxymethyl cellulose and wood pulp. In certain embodiments, the water-dispersible paper comprises wood pulp and a sodium salt of carboxymethyl cellulose.

In certain embodiments, the plastic material comprises polyethylene (PE), polypropylene (PP), polyethylene terephthalate (PET), polystyrene (PS), polyvinyl chloride (PVC), or a combination thereof.

In certain embodiments, the second layer consists of polyethylene. In certain embodiments, the second layer consists of polypropylene.

In certain embodiments, the first layer comprises wood pulp and a sodium salt of carboxymethyl cellulose; and the second layer comprises polyethylene or polypropylene.

In certain embodiments, the packaging material is in the form of a pouch.

In certain embodiments, the packaging material further comprises a third layer directly on the first layer or directly on the second layer. In particular embodiments, the third layer is a varnish or a protective layer.

In certain embodiments, the packaging material consists of the first layer and the second layer.

In certain embodiments, the water-dispersible paper is present in an amount of from about 60 wt. % to about 100 wt. % of the first layer. In certain embodiments, the plastic material is present in an amount of from about 95 wt. % to about 100 wt. % of the second layer.

In certain embodiments, the packaging material is in the form of a pouch and the second layer provides an exterior surface of the pouch. In certain embodiments, the packaging material is in the form of a pouch and the first layer provides an exterior surface of the pouch.

In certain embodiments, the second layer comprises a multilayer film. In particular embodiments, the multilayer film comprises polyethylene and ethylene vinyl alcohol.

In certain embodiments, the second layer is fully covered by the first layer. In certain embodiments, the second layer is only partially covered by the first layer, leaving an area of the second layer exposed. In certain embodiments, the first layer is only partially covered by the second layer, leaving an area of the first layer exposed.

Further provided is a method of making a packaging material, the method comprising extruding a film of a plastic material; coating the film of the plastic material with a water-dispersible material to form a layer stack having a first layer comprising the water-dispersible material and a second layer comprising the plastic material; and forming the layer stack into a package such that one of the first layer or the second layer provides an interior surface of the package and the other of the first layer and the second layer provides an exterior surface of the package.

In certain embodiments, the water-dispersible material consists of a water-dispersible paper. In particular embodiments, the water-dispersible paper comprises carboxymethylcellulose. In particular embodiments, the water-dispersible comprises a salt of carboxymethylcellulose and wood pulp. In particular embodiments, the water-dispersible paper comprises a sodium salt of carboxymethylcellulose and wood pulp.

In certain embodiments, the water-dispersible paper is present in the first layer in an amount of from about 60 wt. % to about 100 wt. %. In certain embodiments, the plastic material is present in the second layer in an amount of from about 95 wt. % to about 100 wt. %.

Further provided is a method for making a packaging material, the method comprising joining together a first layer and a second layer, wherein the first layer comprises a water-dispersible paper and the second layer comprises a plastic material.

Further provided is a packaging material comprising a multilayer film comprising a first layer adjacent to a second layer; wherein the first layer comprises wood pulp and carboxymethylcellulose; and wherein the second layer consists of a synthetic, non-biodegradable polymer. In certain embodiments, the second layer consists of polypropylene or polyethylene.

Further provided is a packaging material comprising a multilayer film comprising a first layer directly adjacent to a second layer; wherein the first layer consists of wood pulp and a salt of carboxymethylcellulose; and wherein the second layer consists of a plastic material. In certain embodiments, the plastic material is polypropylene or polyethylene.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C are side plan views of a packaging material in accordance with some embodiments of the present disclosure. FIG. 1A shows complete coverage of the second layer with the first layer, and FIG. 1B shows partial coverage of the second layer with the first layer. FIG. 1C shows an embodiment having a first layer in between two second layers.

FIGS. 2A-2B show side plan views of first and second layers of the packaging material of FIG. 1, where FIG. 2A is a side plan view of the first layer and FIG. 2B is a side plan view of the second layer.

FIG. 3 is a perspective view of an extruder that can be used in accordance with some embodiments of the present disclosure.

FIG. 4 is a side plan view showing the manufacture of a roll of packaging material in accordance with some embodiments of the present disclosure.

FIG. 5 is a view of a pouch in accordance with some embodiments of the present disclosure.

FIGS. 6A-6F show non-limiting example embodiments of pouches in accordance with the present disclosure, where FIGS. 6A and 6B are views of lay-flat pouches, FIG. 6C is a perspective view of a stand-up pouch, FIG. 6D is a perspective view of a slide-closure pouch, FIG. 6E is a view of a lay-flat pouch with a center spout, and FIG. 6F is a view of a lay-flat pouch with multiple compartments.

FIG. 7 is a bar chart showing the weight loss over time of the SSI 2pt+PE sample and a commercial control described in the examples herein.

FIG. 8 is a line chart depicting the percentage of pulp separation over time for the SSI 2pt+PE sample and a commercial control described in the examples herein.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” or “substantially” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of”. Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless otherwise specified, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combinations of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to”, “directly connected to”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the material in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure is directed to a packaging material (also referred to as a film) constructed from one or more water-dispersible layers and one or more plastic or non-plastic layers. The packaging material is suitable for use with liquids and/or moisture-sensitive solids. The packaging material include a first layer having from about 60 wt. % to about 100 wt. % of a water-dispersible material and a second layer having from about 95 wt. % to about 100 wt. % of a plastic material. The term “water-dispersible,” as used herein, refers to the capability of being at least partially soluble and subsequently partially dispersible (e.g., at least about 70% dispersible) to nearly completely dispersible (e.g., about 100% dispersible) in an aqueous solution, such as water. Dispersion can result in fragmentation of the composition into particulates and/or micro-particulates, where a water-dispersible layer or sheet can fall apart in an aqueous solution into such particulates, leaving only 30% or less of the original structure remaining. Water-dispersible materials, as referenced herein, include materials and papers referred to in the art as “water-soluble,” where only a portion of the paper may be actually soluble in water, but dissolution of this soluble portion results in dispersion of most or all of the remaining structure.

The water-dispersible layer may also be biodegradable. The term “biodegradable,” as used herein, refers to materials that can be readily decomposed by biological methods, through a combination of heat, moisture, and/or microbial action. However, it is not strictly necessary that the water-dispersible material be biodegradable.

In some embodiments, the first layer including the water-dispersible material can accept printing thereon, including registered and random print, where the water-dispersible material can at least partially absorb and/or allow printing inks to dry upon a surface thereof, unlike certain layers that are formed of or that include particular plastics. In this way, the packaging material can be used to package liquids or moisture-sensitive products while maintaining its integrity and further accept printing thereon including customized graphics, labeling, etc. Additionally, or alternatively, the second layer including the plastic material can accept printing thereon, including registered and random print.

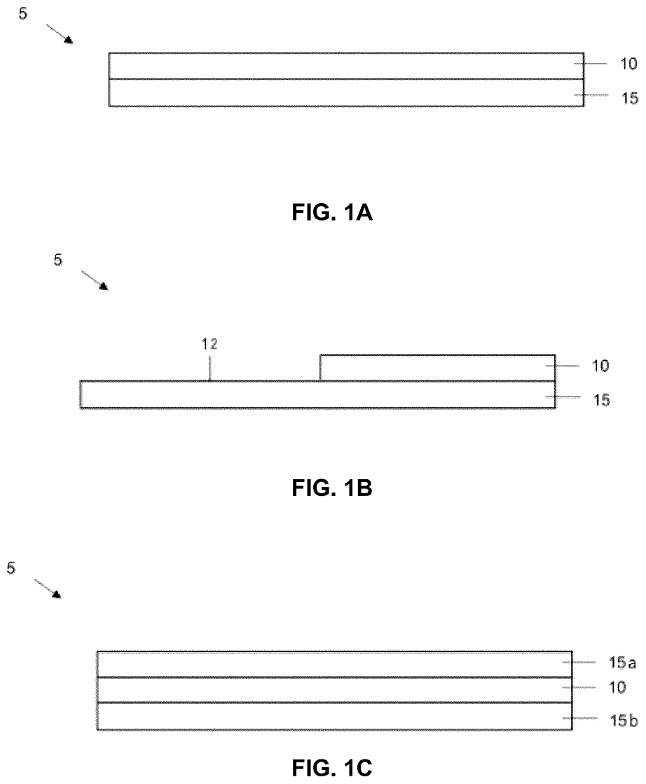

Referring now to FIGS. 1A-1B, a packaging material 5 may be composed of a multilayer structure or film having a first layer 10 and a second layer 15. The first layer 10 and the second layer 15 may be laminated or otherwise adhered or joined to each other. The first layer 10 includes one or more water-dispersible materials, such as a water-dispersible paper. The second layer 15 includes one or more plastic materials. The first and second layers 10, 15 can be joined together to produce the packaging material 5, which can be used to enclose a wide variety of products, including liquids and moisture-sensitive solids. Advantageously, the first layer 10 is dispersible, if not dissolvable, in water, which facilitates easy recycling of the plastic material in the second layer 15.

The first layer 10 and the second layer 15 are adjacent to one another with or without any intervening layer, tie layer, adhesive layer, or other layer therebetween. Thus, in some embodiments, the first and second layers 10, 15 are “directly adjacent” to each other and are in contact without any tie layer, adhesive layer, or other layer therebetween. In other embodiments, an adhesive and/or tie layer is present between the first layer 10 and the second layer 15. In other embodiments, printing ink or other decorations are present between the first layer 10 and the second layer 15.

The first layer 10 and the second layer 15 may completely cover the other, as depicted in FIG. 1A. Alternatively, the first layer 10 may only partially cover the second layer 15, as depicted in FIG. 1B. In embodiments with only partial coverage of the second layer 15, an area 12 of the second layer 15 remains exposed without the first layer 10 thereon. Partial coverage of the second layer 12 by the first layer 10 may be beneficial for various reasons or applications. For example, the area 12 may be more transparent than the remainder of the packaging material 5, thereby providing a window for product visibility. Furthermore, partial coverage of the second layer 15 reduces material cost by reducing the amount of the first layer 10 that is used. Partial coverage may also be better for the breathability of the packaging material 5, which can improve shelf life of certain food items. Furthermore, although an example embodiment in which the second layer 15 is partially covered by the first layer 10 is depicted, it is understood that it is similarly possible for the second layer 15 to partially cover the first layer 10 and thereby leave exposed an area of the first layer 10.

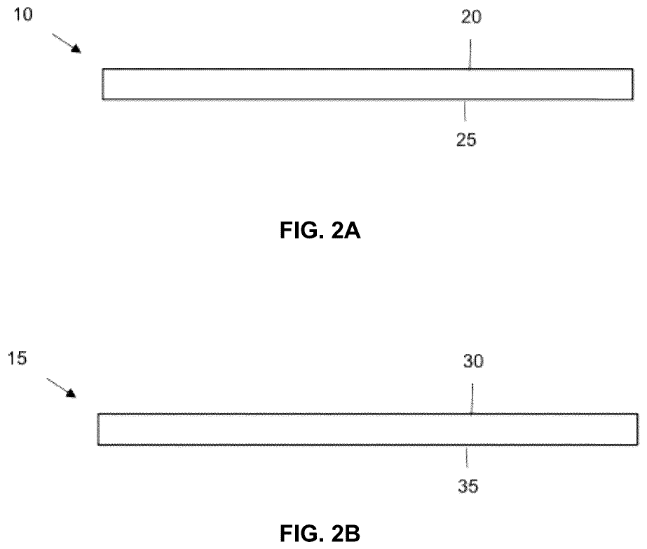

Referring now to FIG. 2A, depicted is an embodiment of the first layer 10. The first layer 10 includes an outer film surface 20 and an inner film surface 25. The outer film surface 20 can be the user-contact surface (e.g., the surface of the packaging material 5 the user directly handles during use), in which case the inner film surface 25 is adjacent to the second layer 15. In other embodiments, the inner film surface 25 is the user-contact surface of the packaging material 5, and the outer film surface 20 is adjacent to the second layer 15. In still other embodiments, neither the inner film surface 25 nor the outer film surface 20 is a user-contact surface, and one of the inner film surface 25 and the outer film surface 20 is adjacent to the second layer 15 while the other of the inner film surface 25 and the outer film surface 20 is adjacent to an additional layer, as described in more detail below.

As noted above, the first layer 10 can include any water-dispersible material, such as (but not limited to) a water-dispersible paper. A water-dispersible material is a substance which can break down or disperse in water. The water-dispersible material may meet the standards of ISO 20200 for disintegration, and/or FG502 for flushability. For example, the water-dispersible material may include polyvinyl alcohol (fully- and partially-hydrolysed polyvinyl acetate), co-polymers based on polyvinyl alcohol (fully- and partially-hydrolysed vinyl acetate copolymers), cellulose ether, lignin, polymers based on polyvinyl pyrrolidone, polyethylene glycol, xanthan gum, guar gum, polyquaternium polymers, pullulan, hydroxypropylmethyl cellulose, hydroxyethyl cellulose, hydroxypropyl cellulose, gelatine, carboxymethylcellulose or salts thereof, sodium alginate, gum tragacanth, acacia gum, gum arabic, polyacrylic acid, methylmethacrylate copolymer, carboxyvinyl polymer, amylases, natural and modified starches, aluminium starch octenylsuccinate, hydroxypropyl starch phosphates, high amylase starch, high amylase hydroxypropylate starch, dextrin, pectin, chitin, chitosan, levan, elsinan, collagen, zein, gluten, soya protein isolate, milk protein isolate, casein, carob bean gum, karaya gum, carrageenan, gellan gum, agar, alginic acid and alginates, furcellaran, polyhydroxy acid polymers, or mixtures thereof.

In some embodiments, the water-dispersible material is biodegradable. The water-dispersible material of the first layer 10 can be characterized by one or more certifications or standards that define certain parameters and/or thresholds for water-solubility and biodegradability, respectively. Water-dispersibility can be related to flushability or dispersability in water and in waste water handling and treatment systems, including septic and municipal waste treatment systems. As noted above, particular requirements for water-solubility include ISO 20200 for disintegration and FG502 for flushability. Biodegradation can include environmental as well as deliberate microbial degradation through composting, aerobic digestion, anaerobic digestion, including treatment through municipal waste management systems. Particular standards for biodegradation include ASTM D6868, OECD 301B, ASTM D5511 for anaerobic degradation, ASTM D5988 for soil degradation, ASTM D5271 for freshwater degradation, ASTM D6691 for marine degradation, and ASTM D6400 for industrial composting. In some embodiments, the water-dispersible material in the first layer 10 of the packaging material 5 is a water-dispersible paper which meets one or more of these standards. In some cases, the water-dispersible material is a water-dispersible paper which meets at least one of the standards for water dispersibility and one or more of the standards for biodegradability. In some cases, the water-dispersible material is a water-dispersible paper which meets all of these standards.

In some embodiments, the water-dispersible material includes, or is composed entirely of, a water-dispersible paper. A water-dispersible paper is a type of paper which breaks down or disintegrates into small fibers when exposed to water. Unlike regular paper, which remains much more intact when wet, water-dispersible paper rapidly degrades in water, facilitating separation of the layers. Water-dispersible paper may meet the standards of ISO 20200 for disintegration and/or FG502 for flushability. In some embodiments, the water-dispersible paper includes cellulose fibers, such as from wood pulp, one or more binders, such as polyvinyl alcohol or a starch-based adhesive, and optional fillers, disintegration agents (such as sodium bicarbonate or dispersants), or surface treatment agents. One non-limiting example of a water-dispersible paper includes a sodium salt of carboxymethyl cellulose and wood pulp. However, many other water-dispersible paper formulations are possible and encompassed within the scope of the present disclosure. In some embodiments, the first layer 10 consists entirely of a water-dispersible paper comprising wood pulp and a salt of carboxymethyl cellulose.

The water-dispersible material in the first layer 10 can make up from about 60% by weight to about 100% by weight of the first layer 10. Optionally, the first layer 10 may further include one or more additives, such as, but not limited to, plasticizers, stabilizers, pigments, dyes, fillers, processing aids, or a combination thereof. The optional additives may be present in an amount ranging from about 0% by weight to about 40% by weight of the first layer 10.

The first layer 10 can have any desired thickness, so long as the first layer 10 provides the desired properties for the particular packaging operation in which the packaging material 5 is used. These properties include, but are not limited to, seal strength, modulus, and the like. Typical layer thickness can range from about 2 mils to 30 mils (e.g., 2 points to 30 points when the first layer 10 is composed of a water-dispersible paper). Thus, the first layer 10 can have a thickness of at least about (or no more than about) 2, 3, 4, 5, 6, 7, 8, 9, 10, 11, 12, 13, 14, 15, 16, 17, 18, 19, 20, 21, 22, 23, 24, 25, 26, 27, 28, 29, or 30 mils.

Referring again to FIG. 2A, in some embodiments, the outer film surface 20 of the first layer 10 can include printed indicia, such as product size, type, manufacturer name, use instructions, artwork, designs, and the like. Any suitable printing method can be used, such as rotary screen, gravure, hydrographic, and/or flexographic techniques. Such printing methods are known to those of ordinary skill in the packaging art.

In some embodiments, the first layer 10 meets the standards for one or more internationally recognized protocols, such as ASTM D6400, OECD 301B, ASTM D6868, EN13432, ISO 14885, ISO 17088, ISO 18606, and AS 4736 for biodegradation and compostability, ISO 20200 for disintegration, and/or FG502 for flushability, each of which is incorporated by reference herein in its entirety.

Referring again to FIGS. 1A-1B, the second layer 15 includes a plastic material. A plastic material is a synthetic or semi-synthetic polymeric substance characterized by its ability to be molded and retain shape under heat and pressure, typically derived from petrochemical sources, and resistant to biological degradation over extended periods in natural environments. In other words, plastic materials as contemplated herein are not biodegradable, unless otherwise noted. Plastic materials have long been used as packaging, to enclose, protect, preserve, and present products for distribution, storage, sale, or use. Plastic materials can typically be made into packaging in a variety of forms such as bags, bottles, wraps, pouches, containers, and films. Plastic materials provide for lightweight packaging (reducing shipping costs and energy consumption during transportation), durability, flexibility, barrier properties, and cost efficiency. Advantageously, the packaging material 5 described herein has characteristics similar to plastic material packaging by virtue of including a plastic material in the second layer 15 while including the non-plastic, water-dispersable material in the first layer 10 which can receive printing, all while being easily recyclable due to the water dispersibility of the first layer 10.

Suitable plastic materials for use in the second layer 15 include, but are not limited to, synthetic thermoplastic polymers (also known as synthetic thermoplastics) such as polyethylene (PE) (including either high-density polyethylene (HDPE) or low-density polyethylene (LDPE)), polypropylene (PP), polyethylene terephthalate (PET), polystyrene (PS), polyvinyl chloride (PVC), ethylene vinyl alcohol (EvOH), or combinations thereof.

Polyethylene, as one example, is a thermoplastic polymer of repeating ethylene units. Its simple chemical structure contributes to its versatility, making it one of the most widely used plastics globally. Polyethylene is useful because of its excellent moisture barrier properties, chemical resistance, and mechanical strength, which are particularly beneficial for forming the exterior surface of packaging materials. When used in the second layer 15, polyethylene may provide additional structural integrity to the packaging material 5, ensuring the packaging material 5 can withstand handling and storage conditions while protecting the contents from external environmental factors such as humidity and liquid exposure. Polyethylene can be produced in a variety of thicknesses, such as from about 0.5 mils to about 2 mils, to meet different packaging requirements. The specific thickness may be adjusted to balance flexibility and strength. Additionally, polyethylene can be processed through various methods, including extrusion coating or lamination, to ensure proper adhesion to the first layer 10.

While conventional polyethylene is not inherently biodegradable, modifications can be made to enhance its environmental degradation. For example, polyethylene can be blended with pro-oxidant additives or other biodegradable polymers and additives to promote faster degradation and microbial assimilation under certain conditions. Polyethylene may also be incorporated with compatibilizers or tie layers to improve the mechanical bond with the water-dispersible first layer 10, ensuring the overall performance of the multilayer film packaging material 5 remains intact during use and disposal.

In some embodiments, the second layer 15 includes from about 95 wt. % to about 100 wt. % polyethylene. The polyethylene used in the second layer 15 can be selected from various types, including low-density polyethylene (LDPE), high-density polyethylene (HDPE), linear low-density polyethylene (LLDPE), and combinations thereof. The choice of polyethylene type can be tailored to achieve the desired balance of flexibility, strength, and barrier properties for specific packaging applications.

Polyethylene can be processed using standard extrusion coating or lamination techniques, allowing the polyethylene to adhere properly to the first layer 10 comprising a water-dispersible material. The compatibility between polyethylene and the first layer 10 can be further improved by incorporating compatibilizers or tie layers, ensuring the integrity and performance of the multilayer film of packaging material 5 during use and disposal.

The incorporation of polyethylene in the second layer 15 provides the packaging material 5 with moisture resistance and durability, protecting the contents from external factors such as humidity and liquid exposure. Additionally, the mechanical strength of polyethylene adds to the structural integrity of the packaging material 5, allowing the packaging material 5 to withstand handling and storage conditions without compromising the protection of an enclosed product.

In some embodiments, the second layer 15 includes a multilayer film. Non-limiting examples of suitable multilayer films for the second layer 15 include those having one or more layers of polyethylene, polypropylene, or ethylene vinyl alcohol. In one non-limiting example, the multilayer film has a structure of polyethylene/tie layer/EvOH/tie layer/polyethylene. EvOH is a copolymer made from ethylene and vinyl alcohol and is used as a barrier material in packaging because of its excellent gas barrier properties, preventing oxygen transmission while maintaining transparency. Thus, such multilayer films are highly effective in preserving the freshness and extending the shelf life of packaged goods, especially when paired with a first layer 10 providing strength and sealability. However, many other multilayer films are possible within the second layer 15.

Referring now to FIG. 2B, depicted is an embodiment of the second layer 15. As shown, the second layer 15 includes an outer film surface 30 and an inner film surface 35. In some embodiments, the outer film surface 30 is adjacent to a surface (i.e., either the inner film surface 25 or the outer film surface 20) of the first layer 10. In such cases, the inner film surface 35 can be the product-contact surface of the film 5 (e.g., the surface directly in contact with the packaged product during use). In other embodiments, the outer film surface 30 is the product-contact surface of the packaging material 5 while the inner film surface 25 is adjacent to a surface of the first layer 10 in the packaging material 5. In still other embodiments, neither the inner film surface 35 nor the outer film surface 30 is a product-contact surface of the packaging material 5, because one of the inner film surface 35 and the outer film surface 30 is adjacent to a surface of the first layer 10 while the other of the inner film surface 35 and the outer film surface 30 is adjacent to an additional layer.

Either of the first layer 10 or the second layer 15 can include various other optional materials and additives. For example, the second layer 15 can include one or more plasticizers, stabilizers, fillers, and/or processing aids including extrusion aids, and the first layer 10 can include one or more plasticizers, stabilizers, fillers, and/or processing aids including coating aids. Each of the first layer 10 and the second layer 15 can also independently include one or more colorants, including pigments and/or dyes. Such additives can be included in the respective layers from about 0.1 wt. % to about 5 wt. %.

Where a filler is included in one or both of the first layer 10 and the second layer 15, the filler can include the following aspects. Fillers can be used to provide opacity and/or to reduce the cost of the first layer 10 and/or the second layer 15. However, the presence of fillers can have an inverse relationship with heat-sealability and adhesion between the water-dispersible material of the first layer 10 and the biodegradable material of the second layer 15. In certain embodiments, it can be desirable to keep the amount of a filler below a certain percentage so that first and second layers 10, 15 can adhere together as desired in forming the multilayer film; e.g., when the second layer 15 is provided as a coating on the first layer 10. Particular embodiments include where the first layer 10 and/or the second layer 15 are limited to 50 wt. % or less of one or more fillers. Examples of certain fillers include starch, gelatinized and non-gelatinized starch blends with other biopolymers or petrochemical polymers, cellulose derivatives, lignin, and/or alginate.

In some embodiments, the first layer 10 and/or the second layer 15 can include alginate as a filler. The alginate can also be accompanied by a calcium solution to crosslink the alginate admixed with the remainder of the material so as to render the alginate insoluble in water but soluble in solutions containing detergents or weak bases. This can increase the strength of the respective layer 10, 15 while not affecting biodegradability of the first layer 10, for example. It is noted that cross-linking alginate can lead to undesirable effects in certain applications, such as where the film is used to package laundry and dish detergents, as a reduction of solubility of the alginate can leave a residue on clothes or dishes when the package and contents are designed to be dispensed together as a unit. The use of alginate and cross-linking thereof can therefore be limited in certain applications.

Each of the first layer 10 and the second layer 15 can have various thicknesses, including where the first layer 10 and the second layer 15 have different thicknesses. Certain embodiments include where the first layer 10 has a thickness from about 2 mils to about 5 mils and/or where the second layer 15 has a thickness from about 0.5 mils to about 2 mils. Each of the first layer 10 and the second layer 15 can independently have a thickness of about 0.5, 1, 1.5, 2, 2.5, 3, 3.5, 4, 4.5, or 5 mils. Other embodiments include where the first layer 10 has a thickness from about 2 mils to about 30 mils and/or the second layer 15 has a thickness from about 0.5 mils to about 5 mils. Some embodiments include layer thicknesses built up of successive layers of the same material; e.g., laminates of layers, successive coatings, etc. Other embodiments include a single, discrete first layer 10 or second layer 15 formed by a single process or operation; e.g., a single extruded film, a single coating, etc. Preferably, at least one of the first layer 10 and the second layer 15 is thick enough to seal, enclose, and protect a packaged product. Moreover, the first layer 10 is thin enough to physically disintegrate or disperse upon application of, or immersion in, water.

As set forth above, in some embodiments the packaging material 5 includes first and second layers 10, 15 positioned directly adjacent to each other, without any additional layers in between or in contact with first and second layers 10, 15. Thus, in some embodiments, the packaging material 5 can be a two-layer film. However, in some embodiments, the packaging material 5 has greater than two layers, and can include one or more barrier layers, core layers, and/or tie layers positioned in between layers 10, 15 and/or or either side of the first and second layers 10, 15. It is also possible to have a varnish applied to the outer surface 20 of the first layer 10, where the varnish is similar or identical to the second layer 15, as described herein.

Referring now to FIG. 1C, the first layer 10 may be sandwiched between two second layers 15a, 15b, where the second layers 15a, 15b are the same or different plastic compositions. In such embodiments, the second layers 15a, 15b may each independently be in direct contact with the first layer 10 or there may be one or more intervening layers such as tie layers between the first layer 10 and one or both of the second layers 15a, 15b. It is understood that similar embodiments in which the second layer 15 is sandwiched between two first layers 10 are also possible and encompassed within the scope of the present disclosure.

The term “barrier layer” refers to a film layer that has a low permeability to gases, such as oxygen. Suitable barrier layer materials can include (but are not limited to) polyvinyl alcohol (PVOH), biodegradable polyesters, silicon dioxide, or blends thereof. The barrier layer can dissolve or physically break down into smaller biodegradable pieces when first layer 10 disperses in water.

As used herein, the term “core layer” can refer to any internal film layer that has a primary function other than serving as an adhesive or compatibilizer for adhering two layers to one another. In some embodiments, the core layer or layers provide the multilayer film of packaging material 5 with a desired quality, such as, level of strength, modulus, optics, added abuse resistance, and/or specific impermeability. The core layer or layers may be able to physically break down into smaller biodegradable pieces when first layer 10 disperses in water.

As used herein, the term “tie layer” refers to any internal layer or layers having the primary purpose of adhering two layers to one another. The tie layer or layers must be able to break down into smaller biodegradable pieces when first layer 10 dissolves in water. Non-limiting example tie layers include maleic anhydride-modified polyolfins, ethylene vinyl acetate copolymers, acrylic-modified polymers, or ionomers (such as ethylene methacrylic acid copolymers).

Various methods of making the packaging material 5 from discrete first and second layer materials are possible. Such methods include, but are not limited to, extrusion coating, and cast film extrusion followed by adhesion. To make the packaging material 5, the second layer 15 can be laminated to the first layer 10. Alternatively, the second layer 15 can be attached to the first layer 10 with a tie layer or an adhesive. The packaging material 5 can be constructed using any suitable method known to those of ordinary skill in the art, including (but not limited to) co-extrusion, lamination, extrusion coating, and combinations thereof. See, for example, U.S. Pat. No. 6,769,227 to Mumpower; U.S. Pat. No. 3,741,253 to Brax; U.S. Pat. No. 4,278,738 to Brax; U.S. Pat. No. 4,284,458 to Schirmer; and U.S. Pat. No. 4,551,380 to Schoenberg, each of which is hereby incorporated by reference in its entirety.

In some embodiments, a method for making the packaging material 5 includes extruding the second layer 15 and coating the second layer 15 with the first layer 10, where the first layer 10 may be formed from a roll of commercially available water-dispersible paper. Also included are methods that extrude one or more second layers 15 and coat the one or more second layers 15 with one or more first layers 10. Certain embodiments include coating a first side 30 of the second layer 15 with a first layer 10 and other embodiments include coating the first side 30 of the second layer 15 with a first layer 10 and coating a second side 35 of the second layer 15 with another material or film, such as an additional second layer 15. Where one layer is coated with another layer, the layer to be coated can be subjected to a corona treatment and/or a plasma treatment to promote adhesion of the subsequently coated layer. Other adhesion promoting techniques can be used to increase adhesion between layers, such as the use of a tie layer between layers of the films, application of an adhesive, and/or texturing methods.

As one example, the plastic material of the second layer 15 can be extruded onto a film of water-dispersible paper using extrusion coating. The water-dispersible paper can be unwound from a roll and passed through tension control systems to ensure smooth feeding into the coating process. The water-dispersible paper may be pre-treated to enhance adhesion with the plastic material. The plastic material can then be melted in an extruder and conveyed through an extruder screw to a coating die where it is forced through a slit die to form a thin, continuous sheet of molten polymer on the water-dispersible paper. The water-dispersible paper and molten plastic material are then immediately pressed together using a chill roll or pressure roller to ensure strong adhesion and a smooth, uniform coating, resulting in the packaging material 5 of the first layer 10 and the second layer 15. The chill roll rapidly cools the plastic material, solidifying it and bonding it to the water-dispersible paper.

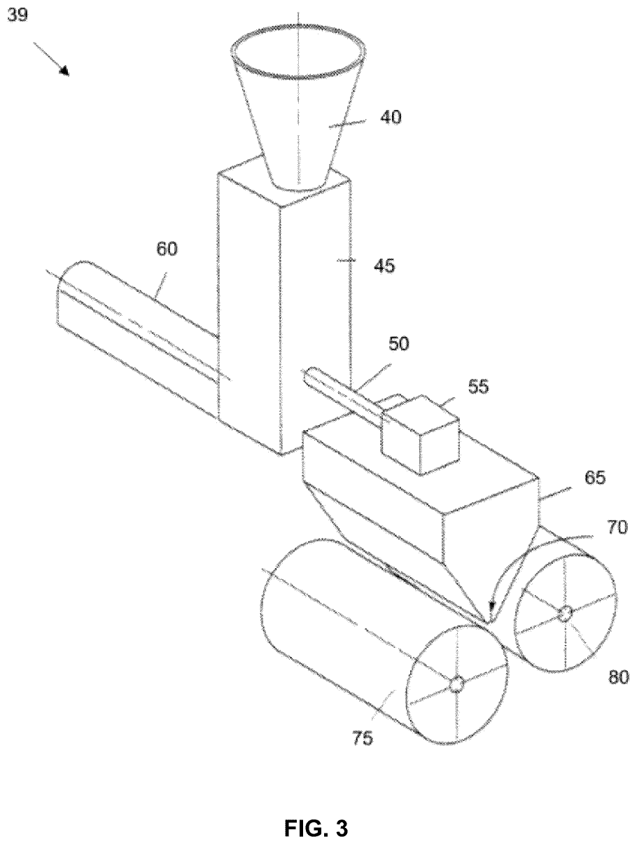

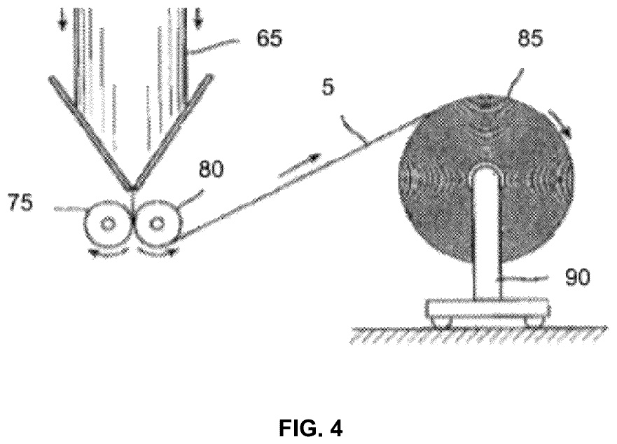

In some embodiments, the packaging material 5 can be constructed using a single screw, slot die extruder as illustrated in FIG. 3. Such an extruder may be used to extrude a film of the second layer 15 and coat the extruded second layer 15 onto the first layer 10. However, it should be appreciated that any extruder may be used. As shown in FIG. 3, the extruder 39 includes a reservoir 40 for loading resin pellets, leading to extruder barrel 45 where the pellets are heated to a melting point of the resin pellets which, in some examples, is about 300° F. Inside the extruder barrel, a rotating screw forces the melted resin through transfer bar 50 and feeding block 55. The rotating screw is driven by motor and armature 60 and can generate pressure to extrude the resin. The extruder 39 includes a slot die 65 that defines a width and provides an even cross-sectional thickness and smoothness to the extruded film. In some embodiments, the slot die 65 can be positioned in the feeding block so that the extruded film exits in a form of a thin curtain. In some embodiments, slot die aperture 70 is at least 0.01 to 0.025 inches wide. The slot die 65 can be positioned over the nip of support roller 75 and pressure roller 80, which can be used to coat one surface of the second layer 15 (e.g., the inner film surface 35) with the first layer 10 to form the film of packaging material 5. The packaging material 5 can then be exposed to ambient air or a similar environment having a temperature sufficiently low to cause molten second layer 15 to transition from a liquid state to a solid state. Additional cooling/quenching of the packaging material 5 can be achieved by providing a cooling bath or winding film on a cooled roll. The resultant film of packaging material 5 can then be wound into a roll 85 by a film winding device 90 as shown in FIG. 4. The film of packaging material 5 on the roll 85 can subsequently be unwound for use (e.g., for packaging applications and/or further processing).

The method can employ heated lamps and/or heated rollers. Where the second layer 15 is extruded and coated onto the first layer 10, a heat lamp (e.g., an infrared heat lamp) can be included in the coating process before a drying station and/or a heated roller (e.g., piping inside of the roller cylinder can circulate heated fluid) is used. Certain plastic materials can be treated at temperatures at or above 350° F. (at or above about 177° C.) to cure and heat-seal the plastic material of the second layer 15. For example, after the second layer 15 is extruded and coated onto the first layer 10, the two-layer film can be subjected to the heat lamp and/or the heated roller to cure the second layer 15 including the plastic material. In this way, the plastic material can be quickly cured onto the first layer 10, which can limit the ability of the contents of the second layer 15 to weaken the first layer 10 which has the water-dispersible material. This avoids compromising the integrity of the first layer 15, which could otherwise result in a break or tear in the film before reaching a dryer station, for example. However, the use of heated lamps and/or heated rollers is not strictly necessary.

Using a heat lamp in making the packaging material 5 can provide several advantages. In particular, subjecting the film to the heat lamp after the second layer 15 is applied to the first layer 10 and prior to exposing the film to a dryer allows a thickness of the second layer 15 to be reduced. A thickness of the second layer 15 can be reduced from 5 mils (or more) down to thicknesses as low as 2 mils. This represents a savings in materials and a cost reduction in the second layer 15. The reduction in thickness of the second layer 15 also allows for the creation of a more flexible film that can be employed in a greater number of packaging and consumer goods applications. In particular, the higher a ratio of plastic material in the second layer 15 to the water-dispersible material (e.g., water-dispersible paper) in the first layer 10, the more rigid the resulting film or packaging is. Conversely, the lower the ratio of plastic material to water-dispersible material, the more flexible the resulting film or packaging is. Positioning the heat lamp prior to a dryer or drying step can also increase crystallinity of a polymer component of the plastic material. Increased crystallinity can result in a stronger and/or more thermally stable second layer 15. Crystallization of a polymer in the plastic material of the second layer 15 can increase the strength and/or thermal stability of the second layer 15 and hence improve fitness of the overall packaging material 5 in certain applications, while allowing a reduction in thickness of the second layer 15. Yet another benefit of using the heat lamp following coating of the second layer 15 with the first layer 10 is a reduction of wrinkling in the film. Wrinkles in the packaging material 5 are minimized by speeding up the curing time (if any) of the plastic material in the second layer 15.

As another example, the second layer 15 can be formed by cast film extrusion and subsequently adhered with an adhesive or tie layer to pre-formed water-dispersible paper. For example, a plastic material resin can be fed into a hopper of an extruder, blended with optional additives, melted, and extruded through a flat die, forming a thin, continuous sheet of molten polymer the thickness of which is primarily determined by the die gap. The molten film can be cooled (i.e., quenched) to solidify and stabilize its dimensions. The film of plastic material can then be oriented or stretched, trimmed to the desired length, and wound onto rolls for further processing. The film can then be adhered to a film of water-dispersible paper to form a packaging material 5 composed of the first layer 10 and the second layer 15.

It is further possible to apply a coating or varnish to the first layer 10. In such a construct, the first layer 10 is intermediate to the varnish and the second layer 15. The varnish can take the form of another second layer 15, where the second layers 15 thereby sandwiches the first layer 10 therebetween. Particular applications can benefit by preventing premature dissolution or dispersion of the water-dispersible material in the first layer 10. Application of a varnish can create a protectant layer that can prevent moisture from causing dispersion of the water-dispersible material. Use of such a varnish can make the packaging material 5 suitable for situations or applications requiring zero or limited dissolution of the first layer 10 before final use; for example, where the packaging material 5 could be exposed to moisture, such as rain or high levels of humidity, while being shipped, as well as protecting the packaging material 5 moisture resulting from human handling, moisture in warehousing environments, or moisture from a humid environment such as a bathroom.

Though methods of making the packaging material 5 involving coating the second layer 15 on the first layer 10 are described for example purposes, it is understood that it is equally possible to coat the first layer 10 on the second layer 15. A water-dispersible material can be coated on a plastic material through any conventional method in order to form the packaging material 5. Examples include, but are not limited to, co-extrusion, extrusion coating, lamination, hot melt coating, solvent or water-based coating (e.g., where a water-dispersible material is applied in a solvent to a plastic substrate via spraying, rolling, or dipping, and the solvent evaporates to leave behind a sold coating), vacuum deposition (e.g., physical vapor deposition, PVD), spray coating, heat sealing or thermal lamination, or roll-to-roll transfer coating. Regardless of which layer 10, 15 coats the other layer 10, 15, a wide variety of methods can be employed to effectively manufacture the packaging material 5.

Various packages can be made from the packaging material 5. Certain embodiments include where the second layer 15 provides an interior surface of the package. In this way, a liquid or a moisture-sensitive product can be disposed within an interior of the package without the water-dispersible material of the first layer 10 dispersing or dissolving. Examples of such products include shampoo, conditioner, and/or body wash. In other embodiments, the one of the liquid and the moisture-sensitive product can include a drink or food item. In another embodiment, the package may be formed where the first layer 10 (i.e., containing the water-dispersible material) forms the interior of the package. In this manner, dry-goods and other goods may be stored within the package. Packages formed from the packaging material 5 can take various forms, such as, but not limited to, a bag, a pouch, a cup, a lid, a plate, a bottle, a tray, and a container. Depending on the composition of the second layer 15, a surface of the second layer 15 may be permitted to contact beverages or foodstuffs in certain locales. The method may further include disposing a liquid or moisture-sensitive product into an interior of the package, followed by sealing the package.

Packages in the form of pouches can be fabricated using the packaging material 5 provided herein. For example, pouches can be constructed where the second layer 15 provides an interior surface of the package and a liquid and/or moisture-sensitive product can be disposed within an interior of the pouch. Certain embodiments include pouches formed using a packaging material 5 having a first layer 10 comprising 3 pt water-dispersible paper along with a second layer 15 comprising a 25 micron coating of a plastic material. The pouches can be constructed in various shapes and forms. For example, four-sided pouches can be formed using two sheets of the packaging material 5, where three sides of each pouch are sealed, the pouches are filled from the open fourth side with various contents, and then the fourth side of each pouch is sealed using an impulse heat-sealer. Examples of contents used to fill such pouches include, but are not limited to, shampoo, conditioner, sunscreen, liquid soap, solid or powdered soap, balm, makeup foundation, lipstick, etc. Such pouches maintain their integrity and the seals remain intact, exhibiting a long shelf-life.

A non-limiting example method of forming a pouch from a film of the packaging material 5 involves first unwinding the packaging material 5 from a roll and feeding the packaging material 5 into a packaging machine under controlled tension to ensure smooth alignment. The film of packaging material 5 can then be shaped into the desired form, such as a tabular structure for center-seal pouches, a folded design for gusseted pouches, or a flat configuration for side-seal pouches. Sealing methods include, but are not limited to, applying heat, applying pressure, or ultrasonic techniques. The sealing methods are used to create the vertical, bottom, or side seals, depending on the pouch type. Once the pouch is partially formed, the pouch can be filled with the intended product through the open end and then sealed completely to enclose the contents. Optional features, such as resealable zippers, spouts, hanging holes, or embossed logos, can be added during the process. The pouch can then be trimmed for a clean finish, and individual units can be separated if produced in multiples. Machines such as vertical or horizontal form-fill-seal systems are typically used, and the entire process can include printing or other enhancements to suit the application. The method creates versatile packages for industries ranging from food to pharmaceuticals to industrial products. However, other methods of forming a package from the packaging material 5 are possible and encompassed within the scope of the present disclosure.

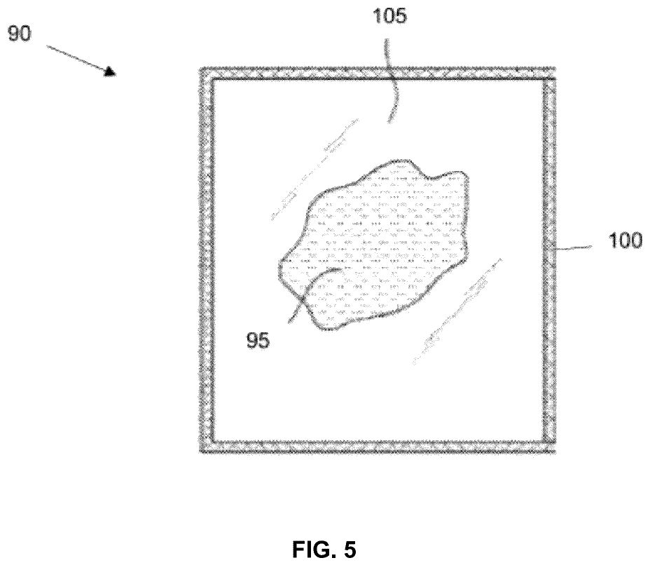

As noted above and with reference to FIG. 5, the packaging material 5 can be used to construct a package 90 that houses one or more liquid and/or moisture-sensitive products 95. The term “liquid product” refers to a product that is in a liquid state at room temperature (about 70° F.). The term “moisture-sensitive product” refers to a product that reacts to moisture, resulting in degradation of a desirable attribute (e.g., such as potato chips that become soggy in the presence of moisture). To this end, the product 95 can be any of a variety of items, such as food, personal care products, and the like. For example, in some embodiments, the packaging material 5 can be used to construct personal care sachets (such as those that commonly house shampoo, conditioner, body wash) and/or snack food packages.

FIG. 5 illustrates one embodiment of a package 90 formed from the packaging material 5 housing a moisture-sensitive product. As shown, the package 90 can include a plurality of edges 100 that are sealed using any known method (e.g., heat seal, adhesive) as described above. The edges 100 extend about the perimeter of the package 90 to form an interior 105 that houses one or more products 95. In some embodiments, at least one edge 100 of the package 90 can be constructed from a fold in the packaging material 5. A user can cut the package 90 open using a sharp device (such as a pair of scissors) to access the product 95. Alternatively, the package 90 can include an easy-open feature such as a spout or slide closure.

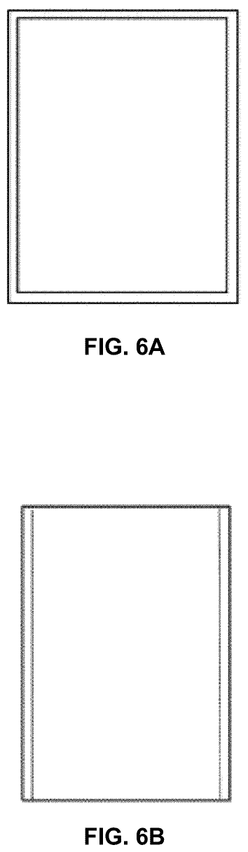

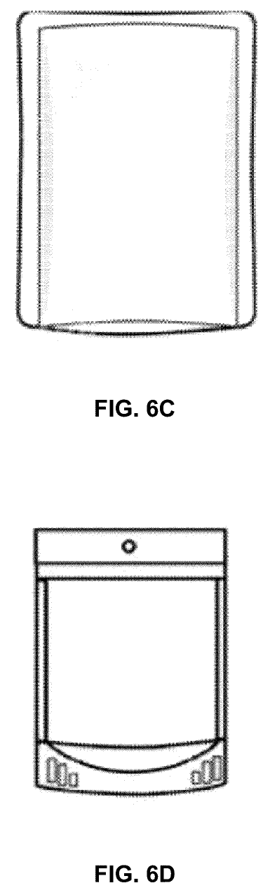

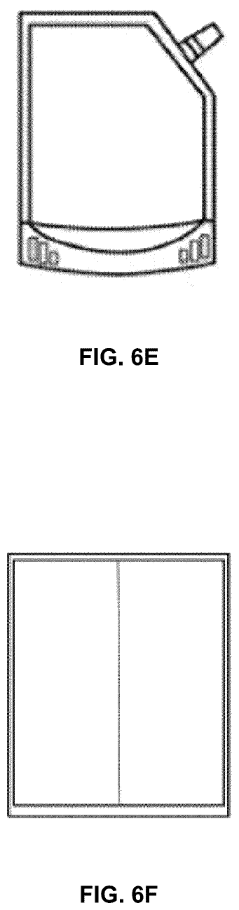

It should be appreciated that package 90 can have any of a wide variety of configurations, as shown in FIGS. 6A-6H. Particularly, package 90 can be constructed as a bag (FIGS. 6A and 6B), a stand-up pouch (FIG. 6C), with a sliding lock closure (FIG. 6D), with a center spout (FIG. 6E), or with more than one compartment (FIG. 6F). It should be further appreciated that the package 90 is not limited to the designs of FIGS. 6A-6G and can be configured in any known shape and can have multiple interior 105 portions that each hold the same or different product 95. Further, the disclosed package 90 is not limited to a pouch design, and can include bottles, containers, cups (e.g., coffee cups), lids, boxes, plates, trays, and the like.

Certain benefits and advantages are attributable to the packaging material 5 described herein, in addition to the printability and flexibility in manufacture thereof. Of particular note is the fact that the first layer 10 can be dispersed, or even dissolved, in an aqueous medium. Dissolution or dispersion of the first layer 10 consequently exposes a substantially greater surface area of the second layer 15. Greater access to the plastic material of the second layer 15 facilitates easier recycling of the plastic material in a process in which mixed plastics or mixed materials cannot be recycled together. Thus, the combination of the water-dispersible material and the plastic material in the respective layers 10, 15 of the packaging material 5 allows a structure suitable for contact and use with liquids and/or moisture-sensitive solids, but which can be disposed of in an environmentally responsible manner by first dispersing the first layer 10, for example washing the first layer 10 off and disposing of the first layer 10 down a drain, and then recycling the plastic material of the now-separated second layer 15. As demonstrated in the examples herein, the first layer 10 is readily removed from the second layer 15 through rinsing or immersion in water. This means that the packaging material 5 can have the properties of a paper/plastic laminate while being quickly and cheaply converted to a plastic material to be recycled without expensive processes. Also, the inclusion of the first layer 10 can address some color and compatibility issues during mechanical recycling processes.

In one non-limiting example, the first layer 10 is a water-dispersible paper layer composed of wood pulp and a sodium salt of carboxymethyl cellulose, and the second layer 15 is polypropylene. Polypropylene is typically recycled by melt reprocessing, where it is often necessary to first sort the polypropylene from other materials and contaminants. However, with the packaging material 5 having a first layer 10 of a water-dispersible material, a second layer 15 of polypropylene is easily isolated by rinsing the packaging material 5 with, or immersing the packaging material 5 in, water. Thus, recycling of the polypropylene in the packaging material 5 can be much simpler, easier, cheaper, and quicker than recycling of polypropylene in conventional plastic-based packaging materials.

In another non-limiting example, the first layer 10 is a water-dispersible paper layer composed of wood pulp and a sodium salt of carboxymethyl cellulose, and the second layer 15 is polyethylene. Polyethylene is also typically recycled by a melt reprocessing method which first involves sorting to isolate the polyethylene from other materials and contaminants. However, with the packaging material 5 having a first layer 10 of a water-dispersible material, a second layer 15 of polyethylene is easily isolated by rinsing the packaging material 5 with, or immersing the packaging material 5 in, water. Thus, recycling of the polyethylene in the packaging material 5 can be much simpler, easier, cheaper, and quicker than recycling of polyethylene in conventional plastic-based packaging materials.

As another advantage, the first layer 10 provides some light barrier properties for the packaging material 5. Having a light barrier in a plastic-based packaging material is advantageous because it may preserve the quality and longevity of the packaged product better or for longer than a packaging material without any light barrier properties. Many food products in particular are sensitive to UV and visible light. The first layer 10 can effectively protect the color and appearance of products within the packaging material 5. Since light exposure can promote microbial growth, a light barrier may reduce the risk of microbial growth within the packaging material 5. Furthermore, some plastic materials break down under light exposure, resulting in brittleness or discoloration. A light barrier can protect the plastic material in the packaging material 5 from these issues. A water-dispersible material, such as a water-dispersible paper, can provide light barrier properties simply by being somewhat opaque.

As another advantage, the first layer 10 can allow for printing on the packaging material 5. More specifically, a water-dispersible paper can enable printing on the first layer 10. Registered print is also possible, where print appears in the same position on successive repeats or on successive sheets or portions of the films. Registered printing can include the use of registered repeats that use an “eyespot” on the film or sheet of the film to allow each print image to be in the same place on each film or sheet. The eyespot (e.g., a thin 1″ by 0.25″ dark colored rectangle) can be located at a corner of the film or sheet and can provide a straight line that the printer system machine eye can “catch” and seal in the same place each printing impression, for example. In certain color printing methods, print registration can include layering of printed patterns to form a multicolor pattern, where registration minimizes position misalignment in overlapped patterns. Printing system machine components, such as a print cylinder, doctor blade assembly, printing plates, stress/friction, etc., can affect registration. Notably, the first layer 10 can effectively be subjected to registered printing, unlike other materials including many plastics and polymers that cannot effectively absorb or allow proper drying of inks, which can result in undesirable spreading, smearing, bleeding, poor resolution, among other issues. The water-dispersible material of the first layer 10 can provide a suitable substrate for various registered printing methods, including those employing dye-based and pigment-based aqueous inks.

Registered printing may also be added to the second layer 15 of the packaging material 5. The plastic material in the second layer 15 may be printed with various types of inks, including but not limited to: water-based inks, soy-based inks, vegetable-based inks, bio-based inks, plant-based inks, edible inks, algae inks, digital inks, VOC-free inks, UV-curable inks, and biodegradable inks. Registered printing may be printed onto the plastic material using digital printing, a digital toner, inkjet printing, flexography, offset printing, offset lithography, large format printing, 3D printing, screen printing, laser printing, thermal transfer printing, or direct thermal printing.

### EXAMPLES

An experiment was conducted to evaluate the disintegration properties of a packaging material with a first layer of water-dispersible paper (2-point, or approximately 0.71 mm, thickness) extrusion-coated with polyethylene (PE), referred to as SSI 2pt+PE. This sample was compared to a commercial control using a slosh box test, following the IWSFG PAS 3:2018 protocol. The SSI 2pt+PE sample exhibited a white color, while the commercial sample exhibited a brown color.

In the experimental setup, 5-inch by 5-inch samples were cut from both the SSI 2pt+PE material and the commercial control. Each sample was weighed prior to testing. The slosh box conditions were as follows: the box had dimensions of 12 inches by 18 inches, a water volume of 4 liters, a temperature maintained at 25° C., a maximum inclination of ±11 degrees, and a rotation speed of 18 RPM.

The samples were subjected to agitation in the slosh box for specified time intervals of 1, 5, 10, 20, and 30 minutes. At each time point, the samples were removed and dried in an oven at 50° C. to determine the weight loss and percentage of pulp separation. The weight loss was calculated to assess the global disintegration of the samples overtime.

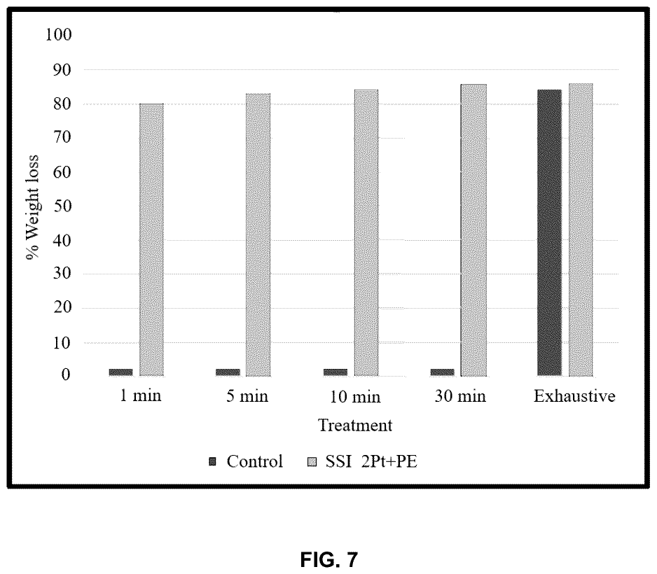

FIG. 7 illustrates a bar chart showing the global weight loss of the SSI 2pt+PE sample and the commercial control at various time intervals. The SSI 2pt+PE sample exhibited a rapid weight loss, with approximately 80% weight loss after 1 minute, around 82% after 5 minutes, 83% after 10 minutes, and reaching approximately 85% after 30 minutes. Beyond 30 minutes, the weight loss plateaued at around 85%. In contrast, the commercial control showed minimal weight loss, remaining below 5% at the 1, 5, 10, and 30-minute intervals, and only reaching about 82% weight loss after an exhaustive amount of time.

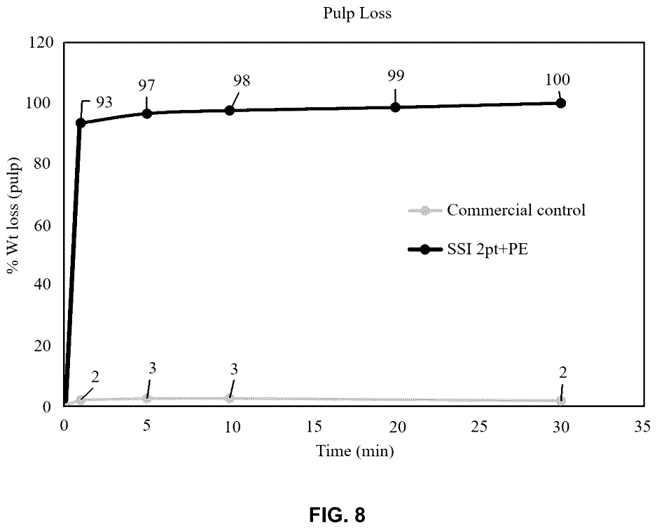

FIG. 8 presents a line chart depicting the percentage of pulp separation over time for both samples. The SSI 2pt+PE sample demonstrated a rapid pulp separation of 93% after just 1 minute, increasing to 97% at 5 minutes, 98% at 10 minutes, 99% at 20 minutes, and achieving complete separation (100%) at 30 minutes. In stark contrast, the commercial control exhibited negligible pulp separation, with only 2% at 1 minute, 3% at 5 minutes and 10 minutes, and remaining at 2% even at 30 minutes.

These results indicate that the SSI 2pt+PE material undergoes significantly faster pulp separation compared to the commercial control under the same conditions. The inclusion of polyethylene in the second layer does not hinder this process. The polyethylene contributes to the material's structural integrity during use while still allowing for swift dispersion of the water-dispersible material upon exposure to water.

The experiment confirmed that the SSI 2pt+PE material achieves quantitative separation of the pulp within the first 10 minutes of the test, highlighting its superior performance over the commercial equivalent. This rapid disintegration is beneficial for reducing environmental impact, as the water-dispersible material readily breaks down in water, leaving behind a plastic material ready for recycling.

Polyethylene Film Coated with Polyvinyl Alcohol

In another non-limiting example, the second layer 15 is a polyolefin film, which can optionally be recyclable, provided separately from a first layer 10, or in combination with a first layer 10, as described herein. The polyolefin film (e.g., polyethylene, polypropylene, or a blend of the two) can comprise any suitable is coated with a thin film of polyvinyl alcohol (PVA). The coating of PVA can have a thickness between 5 and 25 microns. The PVA utilized in this non-limiting example has a degree of hydrolysis between 40% and 80%, which provides a balance between water solubility and film integrity under standard storage and use conditions. The PVA coating may be applied by extrusion coating, gravure coating, or other wet coating techniques. The resulting composite film exhibits good interlayer adhesion while maintaining recyclability through aqueous separation of the PVA layer.

Polyethylene Extrusion onto Water-Soluble Paper

In another non-limiting example, the second layer 15 is a polyolefin film, which can optionally be recyclable, provided separately from a first layer 10, or in combination with a first layer 10, as described herein. The polyolefin film (e.g., polyethylene, polypropylene, or a blend of the two) is extruded directly onto the first layer 10. The first layer 10 comprises a water-soluble paper stock that has a thickness between 38 and 127 microns (1.5 mils-5 mils), depending on the desired mechanical properties and end-use requirements for flexible packaging. The extrusion may be carried out at any suitable temperature, such as temperatures between 9° and 250° C., with the extrudate thickness (average—12 to 50 microns) controlled to achieve a total laminate thickness of approximately 50 to 177 microns.

### Polyethylene Laminated to Water-Soluble Paper Composite

In another non-limiting example, the second layer 15 is a polyolefin film, which can optionally be recyclable, provided separately from a first layer 10, or in combination with a first layer 10, as described herein. The polyolefin film (e.g., polyethylene, polypropylene, or a blend of the two) is laminated onto a first layer 10. The first layer 10 comprises a paper composite comprising a layer of water-soluble paper and a layer of water-soluble polyvinyl alcohol serving as a release layer. The lamination process may be performed using heat in any suitable range, such as heat in the range of 85 to 210° C. Optionally, the lamination process can be performed with an aqueous or solvent-free adhesive to ensure compatibility with the water-soluble nature of the structure. Upon immersion in water, the PVA release layer dissolves, enabling clean separation of the second layer 15 (e.g., polyethylene film) from the first layer 10 (e.g., paper substrate).

Polyethylene Laminated to Regular Paper with Soluble Release Layer

In another non-limiting example, the second layer 15 is a polyolefin film, which can optionally be recyclable, provided separately from a first layer 10, or in combination with a first layer 10, as described herein. The polyolefin film (e.g., polyethylene, polypropylene, or a blend of the two) is laminated onto a first layer 10. The first layer 10 comprises a composite comprising a layer of conventional paper and a layer of water-soluble polyvinyl alcohol as the release layer. This configuration allows conventional paper to be used while still enabling delamination and recovery of the polyethylene film after exposure to water under controlled pH and temperature conditions. The paper basis weight may range from 30 to 120 g/m².

### Release Layer of Alternative Water-Soluble Biopolymers

In another non-limiting example, a release layer included in a packaging material is formed from an alternative water-soluble biopolymer such as alginate, pectin, or hyaluronic acid. A release layer included in a packaging product can be substituted for, used in combination with, or contact, an intervening layer, tie layer, an adhesive layer, a first layer, and/or a second layer, as described herein. The polymers used for a release layer may be applied as aqueous coatings with a solids content between 5 and 50 wt. %, optionally crosslinked or plasticized to adjust solubility and mechanical strength. The dissolution behavior of these materials can be tuned to occur within a pH range of 6 to 10, enabling compatibility with typical recycling wash conditions.

Release Layer Made from Biobased Materials

In another non-limiting example, a release layer included in a packaging material comprises a material selected from Table 1 and applied to a first layer 10 and/or a second layer 15. The release layer can be applied to a first layer 10 and/or a second layer 15 using thermal extrusion within the heat range shown in Table 1. A first layer 10 (e.g., biodegradable layer) or second layer 15 can be deposited through thermal extrusion to apply the release layer (e.g., peptide-based layer) in the range of 10-50 microns to the first layer 10 or the second layer 15. Yielding a continuous, water-soluble or water dispersible film that acts as a releasable interface between the second layer 15 (e.g., polyethylene film) and the first layer 10 (e.g., paper substrate). The release layer (e.g., protein layer) dissolves in aqueous environments within the pH range of 6-8, allowing delamination during recycling.

TABLE 1

| Protein material | Temperature of application |
|---|---|
| Casein | 80-150° C. |
| Whey protein isolate (WPI) | 50-150° C. |
| Soy protein isolate (SPI) | 60-140° C. |
| Corn zein | 80-190° C. |
| Wheat gluten | 45-140° C. |

### Printing and Additional Processing

In any of the embodiments described herein, a packaging material may be register-printed using water-based or organic solvent-based inks, depending on end-use requirements. The printed composite may further be converted into pouches, wraps, or labels using standard packaging machinery.

Certain embodiments of the compositions and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A packaging material comprising:
a first layer comprising a water-dispersible paper, wherein the first layer meets at least one requirement selected from the group consisting of ISO 20200 for disintegration and FG502 for flushability; and
a second layer in direct contact with the first layer, the second layer comprising a plastic material.

2. The packaging material of claim 1, wherein the packaging material consists of the first layer and the second layer.

3. The packaging material of claim 1, wherein the water-dispersible paper comprises carboxymethyl cellulose and wood pulp.

4. The packaging material of claim 1, wherein the plastic material comprises polyethylene (PE), polypropylene (PP), polyethylene terephthalate (PET), polystyrene (PS), polyvinyl chloride (PVC), or a combination thereof.

5. The packaging material of claim 1, wherein the second layer consists of polyethylene.

6. The packaging material of claim 1, wherein the second layer consists of polypropylene.

7. The packaging material of claim 1, wherein:
the first layer comprises wood pulp and a sodium salt of carboxymethyl cellulose; and
the second layer comprises polyethylene or polypropylene.

8. The packaging material of claim 1, further comprising a third layer directly on the first layer or directly on the second layer.

9. The packaging material of claim 8, wherein the third layer is a varnish or a protective layer.

10. The packaging material of claim 1, wherein the water-dispersible paper is present in an amount of from about 60 wt. % to about 100 wt. % of the first layer.

11. The packaging material of claim 1, wherein the plastic material is present in an amount of from about 95 wt. % to about 100 wt. % of the second layer.

12. The packaging material of claim 1, wherein the second layer comprises a multilayer film and comprises polyethylene and ethylene vinyl alcohol.

13. The packaging material of claim 1, wherein the second layer is fully covered by the first layer.

14. The packaging material of claim 1, wherein the first layer is only partially covered by the second layer, leaving an area of the first layer exposed or the second layer is only partially covered by the first layer, leaving an area of the second layer exposed.

15. A method of making a packaging material, the method comprising:
extruding a film of a plastic material;
coating the film of the plastic material with a water-dispersible material to form a layer stack having a first layer comprising the water-dispersible material and a second layer comprising the plastic material; and
forming the layer stack into a package such that one of the first layer or the second layer provides an interior surface of the package and the other of the first layer and the second layer provides an exterior surface of the package.

16. The method of claim 15, wherein the water-dispersible material consists of a water-dispersible paper.

17. The method of claim 16, wherein the water-dispersible paper comprises carboxymethylcellulose.

18. The method of claim 16, wherein the water-dispersible material comprises carboxymethylcellulose and wood pulp.

19. The method of claim 15, wherein the water-dispersible material is present in the first layer in an amount of from about 60 wt. % to about 100 wt. %.

20. A packaging material comprising:
first layer comprising a polyolefin film; and
a second layer adjacent the first layer, the second layer comprising a water-dispersible paper.
